(19) United States
(12) Patent Application Publication
(10) Pub. No.: US 2015/0043609 A1
(43) Pub. Date: Feb. 12, 2015

(54) PROCESS AND EQUIPMENT FOR THERMAL CYCLING TESTING OF ODONTOLOGICAL MATERIALS

(71) Applicant: Odeme Equipamentos Médicos e Odontológicos Ltda, Luzerna/ Santa Catarina (BR)

(72) Inventors: Rafael Tiago Patzlaff, Santa Catarina (BR); Alessandro Dourado Loguercio, Parana (BR); José Roberto de Oliveira Bauer, Maranhao (BR); Saulo Geraldeli, Gainesville, FL (US)

(21) Appl. No.: 14/454,533

(22) Filed: Aug. 7, 2014

(30) Foreign Application Priority Data
Aug. 8, 2013 (BR) BR10 2013020286-0

(51) Int. Cl. G01N 25/72

(52) U.S. Cl. CPC G01N 25/72
USPC 374/47

(57) ABSTRACT

Concerns a process to execute thermal cycling tests on odontological materials in a specific equipment, with the basic goal of accelerating the decay of the interface between different materials, and the intrinsic decay of the test object itself, and of simulating oral conditions, keeping the test object fixed in the interior of a test chamber, isolated from the external environment, and the internal environment being adjusted to the desired temperature by way of liquids in diverse temperatures, contained in vats.

The process consists of executing thermal cycling tests of odontological materials in a specific equipment. It is used to execute the thermal cycling test of odontological materials and teeth with the basic goal of accelerating the decay of the interface between different materials, and the intrinsic decay of the odontological material test object itself, and simulating oral conditions.

One of the most used tests in the odontological field to verify the efficiency of different dental materials is the thermal cycling test, also known as thermocycling. This test has the function of simulating the different conditions the restored dental elements will be subject to when drinks and/or liquid foods of different temperatures and in varying time intervals are ingested. For example, in some occasions one might ingest a drink or a liquid food, like a hot soup, and soon after ingest another liquid that might be, for example, at room temperature, or even cold. This action causes a thermal shock on the dental element, on the restoring material and, consequently, on the restored interface.

Basically, in the thermocycling test restored teeth are used in the form of test objects. The test induces thermal stress on the interface and in the materials therein contained. This stress occurs due to the test object's expansion when heated, and contraction when cooled; the expansion varying directly according to the interface materials' linear thermal dilation coefficients. This thermal shock simulation induces the propagation of previously existing fissures, as well as the formation of fissures on the interface, enlarging the marginal infiltrates. Through this same phenomena, it has already been shown a diminishing of the union values through time when teeth were submitted through the thermocycling test. During the thermocycling tests, the test objects are submerged in distilled water. Consequently not only thermal shock, but also hydrolysis in water, specially in hot temperature, exactly as it occurs in the oral cavity, is another factor that diminishes the union values on the restored interface as a result of aging.

In the current state of the art, the thermocycling test equipment basically consists of three tubs with water in three different temperatures. One tub contains cold water with a temperature of approximately 5° C.; another tub contains hot water with a temperature of approximately 55° C.; and the other tub contains water with an intermediate temperature, closer to room temperature, with a temperature of approximately 37° C. The test comprehends primarily the immersion of a certain amount of restored teeth, in the form of test objects, laying in a basket, into one of the liquid-filled tubs. The act of submerging the test objects is known as bath. After being submerged, the test objects remain in the tub for a predetermined amount of time before being moved into another tub, and so on, being that the complete immersion in the baths consists of one full cycle. The temperature of each tub can be altered according to the study to be executed, that is, through a regulating system the researcher may alter the temperature of the tub, setting the temperature that best adjusts to their experiment, according to the conditions they would like to simulate. The test objects can be immersed in the tubs in different cycles, that is, one may submerge the test objects in the hot bath, then in the intermediate bath, and then in the cold bath. However, according to the needs of the researcher, one might submerge the test objects in only two of the baths described. A complete cycle consists of three baths, however one may have cycles with only two baths, only hot and cold, cold and intermediate, or intermediate and hot. Systematically, the test objects alternate baths, after the ending of each new cycle. For these reasons the test is known as thermal cycling, as different test objects are cycled through different temperatures.

To execute the test a machine is utilized that is called the thermal cycling machine. The configuration of the machine varies according to each manufacturer. They are generally presented with two or three tubs of liquid, usually water. Each of the tubs has its own temperature control, and the operating principle of the machines varies from mechanical systems to electropneumatic systems. The Erios company, based in the city of São Paulo-SP, markets electropneumatic equipment with 3(three) immersion tubs. The Elquip company, based in the state of São Paulo, markets equipment with 3(three) immersion tubs, being two with a heating system and one with a cooling system; making possible baths of intermediate temperature (37±1° C.), cold (5±1° C.), and hot (55±1° C.); permitting the use of three tubs or just two; the immersion time on the tubs being adjustable. The Biopdi company, based in the city of São Carlos-SP, markets equipment with 3(three) immersion tubs with a capacity of 10, 15, or 20 liters, depending on the model of the equipment. The SD mekatronic company, based in Germany, markets equipment with 2(two) immersion tubs, being one with a hot bath, from 25° C. up to 100° C., and the other with cold bath, from −5° C. up to 35° C. The Ethick technology company, based in Vargem Grande Paulista-SP, markets equipment with two tubs with up to 18 liters; it has a digital indicator for temperature regulation, and automatic filling. The equipments, in the current state of the art, have as principle the moving of a test object from one tub into the other, where it remains submerged for a certain amount of time, and it is then taken out of this tub and submerged into another tub that contains liquid of a different temperature.

Although it is a proven test when it comes to its functionality and results, several points have been observed that require improvement to make the test more accurate to the real conditions materials will be submitted to when used in vivo. Among the points that require improvement, here are some highlights:
difficulty to maintain the correct temperature of the liquid in the tubs;
freezing of the liquid in the cold water tub;
thermal exchange of the test objects with the water in the tub, resulting in an initial immersion temperature that is different of the final temperature of the bath. This results not only in a problem in the point of view of interpreting the data, but also creates a higher energy consumption due to the necessity of the heating and cooling systems having to work uninterruptedly;
the test objects, due to the thermal exchange with the liquid in the tub, cannot, in the determined amount of time, homogenize the temperature so that there is, in fact, thermal shock occurring along the whole of the test object, which is fundamental to the experiment;
during the test object's transport between baths, they are exposed to a dry environment, leading to an intense thermal exchange, creating an increase or decrease in the test object's temperature, according to the current room temperature, which is detrimental to the test;
when the test objects are taken out of a tub, a certain amount of water stays on the test object, making it so that the basket containing the test object will drip for some time. This small amount of water enters the next tub, increasing or diminishing its water temperature, and that is another reason for the difficulty in maintaining the temperature;
the majority of the machines in the present state of the art present mechanical sets to move the basket that contains the test objects from one tub to the next. These sets suffer fatigue in a short amount of time, damaging the equipment, which often leads researches to leave out the use of this type of test equipment.
since the tubs are exposed to the environment, evaporation of the hot liquid occurs, making necessary its permanent replenishment for the duration of the test.

The Process and Equipment for Thermal Cycling Testing of Odontological Materials described in this report is characterized by keeping the test object fixed in the interior of a test chamber, isolated from the external environment, and the environment inside the chamber being adjusted to the desired temperature, usually simulating the environment found inside the oral cavity. The equipment has three vats of liquid in diverse temperatures, and hoses to transport the liquid, via hydraulic pumps, from the vats to the test object. With the aid of electro-electronic commands, the pumps are activated individually, according to the baths sequence, programmed beforehand, pumping liquid out from the vats and over the test object, which is positioned in a support inside the test chamber. The test object remains stationary in one location and the liquids from the vats are pushed to it. The liquids of each vat bathe the test object in a sequential manner according to the programmed cycle.

To complement the invention's description and with the intent of facilitating the comprehension of its characteristics, a series of images are presented, in an illustrative and non-limiting character.

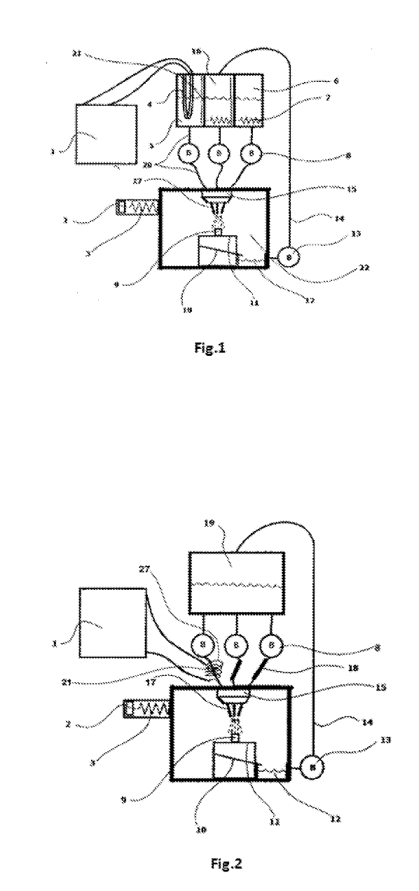

The FIG. 1 shows the preferential configuration of the EQUIPMENT that makes viable the Process for Thermal Cycling Testing of Odontological Materials.

The FIG. 2 shows a second constructive configuration of the EQUIPMENT that makes viable the Process for Thermal Cycling Testing of Odontological Materials.

According to FIG. 1, the preferential configuration of the equipment for thermal cycling testing consists of three vats (5, 6, and 16) in which a certain amount of liquid is put. The vats have the purpose of accommodating liquid for the hot, cold, and intermediate baths. In two vats (6; 16) there is an electrical resistance (7) which, after being activated by the machine's electrical command, will heat the liquid to the desired temperatures for the hot and intermediate baths. In the other vat (5) there is a coil (4) connected to a refrigeration module (1), whose function is to cool the liquid to the desired temperature to be used for the cold bath. The vats are separated by a thermal insulator (21) so that there is no thermal exchange between them, thus guaranteeing better efficiency for the system. Temperature sensors indicate when the liquid's temperature is at the correct temperature that is been regulated and desired. With the aid of electro-electronic commands, pumps (8) are activated according to the baths initial programmed sequence, transferring liquid from the vats through hoses (20), through the fixating headstock (15) of the injection nozzles (17), reaching the test object (9) that is positioned and fixated on a support (11). Said support (11) has grooves and holes so that the liquid, after contacting the test object (9), drains off to be directed (10) to the liquid collecting drawer (12). Through the pump (13) the liquid is transferred via hose or tubing (14) to its respective vat (5; 6, and 16) remaking the cycle. The test object (9) is located on the test chamber (22). This chamber is isolated from the external environment and, through a heating set (2 and 3), the internal environment is adjusted to the desired temperature, thus simulating the temperature conditions of the human mouth. The heating set is composed of a fan (2) that creates an air current which flows through an electrical resistance (3). The passage of air through the resistance heats it and it is then launched into the test chamber (22) so as to create a controlled temperature for the sample. The hoses used for transporting liquid from the vats (5, 6, and 16) to the test object (9) are thermally isolated so as to guarantee a smaller loss or gain of heat during the liquid's travel.

The heating generated by the electrical resistance (7) can be created via induction, via solar energy, via combustion, via heat exchanger, or via forced air.

The pumps (8) that transport and inject the liquid from each vat (5, 6, and 16) onto the test object (9) can work via piston, via peristaltic pump, via gravity, via water grid, alternate pump, rotary vane pump, liquid ring pump, diaphragm pump moved by compressed air, gear pump, screw pump, pneumatic pump, centrifugal pump, kinetic pump, submersible pump, single-vane pump, and piston pump.

The refrigeration module (1) can be constituted of a cooling system with compressor, cooling system with forced air, heat exchange, coil with ice and by nitrogen.

The air that is launched into the test chamber (22) so as to create a controlled temperature for the sample can be heated via electrical resistance or thermal hose, or induction, or solar energy, or combustion heating, or by heat exchange, or forced air.

### Advantages of the System

Exposes the test object to the conditions of the human oral temperature in a more accurate manner.
It is possible to simulate with great precision the act of contacting liquids of different temperatures, which is what happens in the oral cavity.
Diminishes the heat exchange of the samples with the external environment, resulting in a more accurate test when compared to other types of existing machines.
It has a chamber with controlled temperature which enhances the realism of the test, once the temperature teeth are normally subject to is the body temperature, that is, 37° C.
More precise maintenance of the temperature of the liquid when it contacts the test object.
Eliminates the problem of liquid evaporation, which is very common in equipments in the current state of the art.
Eliminates the problem of thermal exchange between the test object and the water, avoiding losses and guaranteeing the correct temperature.
Due to the circulation of the cold liquid, the liquid gains energy and avoids freezing;
Due to the circulation of the hot liquid, the liquid gains energy and avoids evaporating;
Eliminates the use of motors for handling and moving the test objects, this factor which is responsible for the low durability of the equipments.
The liquid flow is continuous and in regulated temperature, making the samples's bath process more uniform. The current methods cannot guarantee that along the time during which the test objects are being bathed, regulated temperature can be maintained.
Bivolt input voltage.
Many types of test liquid can be used, such as: water, distilled water, coffee, tea, sodas, wines, juices, methylene blue, gentian violet, silver nitrate.
The present model of equipment is simpler to be manufactured if compared to the current state of the art.
It allows the use of electronic controls for a great number of variables.

### Variants in the Process of Thermal Cycling Testing of Odontological Materials

The vats of the equipment main contain, instead of distilled water, different colorings so as to not only simulate thermal exchange, but also the ingestion of colorings during the thermal exchange. This allows the equipment to be used for other applications, such as: simultaneous analysis of thermal exchange and coloring ingestion, or also the effects of thermal exchange on the superficial color of aesthetic restoring materials.

### Variants in the Manufacturing of the Equipment of Thermal Cycling Testing of Odontological Materials

In FIG. 2 the system may be seen, with the same inventive idea, assembled in a second configuration. The claimed process, in this case, uses one single vat (19) and the heating or cooling of the liquid occurs as it travels from the pump (8) to the test object (9). For heating the liquid, thermal hose (18) conduces the liquid through its interior and at the same time heats the liquid. These thermal hoses (18) have internal temperature sensors that allow temperature measurements to be taken on the exit of the thermal hose (18), as well as automatically adjusting towards the desired temperature by regulating the power of the resistance that is located in its interior. For cooling the liquid, a coil (27) is located between the pump (8) and the test object (9). The refrigerated coil (27) will be in contact with the liquid transporting hose (21). As the liquid flows through the hose (21), the liquid cools down, through thermal exchange, reaching the test object (9) in the desired temperature.

Both constructing sets, represented by FIGS. 1 and 2, are controlled by an electro-electronic system where the number of cycles is counted, the injection time controlled, and it automatically shuts off. Although the claimed object in this report justifies its functionality in dental restoring materials, its application may be utilized in adherence testing of different materials in other realms of knowledge.

1. PROCESS AND EQUIPMENT FOR THERMAL CYCLING TESTING OF ODONTOLOGICAL MATERIALS that induces thermal stress on the interface and on distinct materials, constituted of a plurality of vats (5, 6, and 16) which contains, respectively, hot, cold and intermediate liquids, characterized by the liquids being transported and injected, by pumps (8), over the test object (9), being the test object (9) positioned and fixed on a support (11), inside a test chamber (22) that is isolated from the external environment and with its inside temperature adjusted via a heating set, and recycling the residual liquid from the test chamber (22), via a hydraulic pump (13), transferring the liquid through hose or tubing (14) to its respective vat (5, 6, and 16).

2. PROCESS AND EQUIPMENT FOR THERMAL CYCLING TESTING OF ODONTOLOGICAL MATERIALS, according to claim 1, characterized by a heating set to be composed by a fan (2), that creates an air current which passes through an electrical resistance (3).

3. PROCESS AND EQUIPMENT FOR THERMAL CYCLING TESTING OF ODONTOLOGICAL MATERIALS, according to claim 1, characterized liquid contained in vats (5, 6, and 16) of the equipment may contain different colorings.

4. PROCESS AND EQUIPMENT FOR THERMAL CYCLING TESTING OF ODONTOLOGICAL MATERIALS, characterized by comprising a single vat (19) and the heating or cooling of the liquid occurring in transit from the pump (8) to the test object (9).

5. PROCESS AND EQUIPMENT FOR THERMAL CYCLING TESTING OF ODONTOLOGICAL MATERIALS, according to claim 4, characterized by the heating of the liquid occurring through thermal hoses (18) that lead the liquid through their interior while heating the liquid, and the thermal hoses (18) having internal temperature sensors.

6. PROCESS AND EQUIPMENT FOR THERMAL CYCLING TESTING OF ODONTOLOGICAL MATERIALS, according to claim 4, characterized by the cooling of the liquid occurring through a cooling coil (27), and the cooling coil (27) being in contact with the liquid transporting hose (21).
